(19) United States
(12) Patent Application Publication
(10) Pub. No.: US 2015/0317336 A1
(43) Pub. Date: Nov. 5, 2015

(54) DATA RECONSTRUCTION

(71) Applicant: Hewlett-Packard Development Company, L.P., Houston, TX (US)

(72) Inventors: Vladimir Dubsky, Podebrady (CZ); Miroslav Malecha, Prague (CZ); Pavel Zavora, Prague (CZ)

(73) Assignee: Hewlett-Packard Development Company, L.P., Houston, TX (US)

(21) Appl. No.: 14/266,531

(22) Filed: Apr. 30, 2014

(51) Int. Cl. G06F 17/30

(52) U.S. Cl. CPC G06F 17/30294; G06F 17/30917

(57) ABSTRACT

In one implementation, a system for data reconstruction includes a data model engine to generate a data model and receive a plurality of different data types to include within the data model. In addition, the system includes a shortcut engine to define shortcut types. In addition, the system includes a categorization engine to identify a shortcut within the data model and categorize the identified shortcut into the defined shortcut types. In addition, the system includes an intermediary engine to determine unknown intermediaries of the identified shortcut based on the received plurality of different data types.

### BACKGROUND

A cloud computing network can utilize a variety of network tools to automated deployment, arrangement, coordination, and management of computer systems, middleware, and/or services from the cloud computing network. The network tools can receive and/or gather information that relates to the cloud computing network. The network tools can utilize information that relates to the cloud computing network to provide additional services to the cloud computing network and/or provide data to a user.

### BRIEF DESCRIPTION OF THE DRAWINGS

FIG. 1 illustrates a diagram of an example of a system for tool synchronization according to the present disclosure.

FIG. 2 illustrates a diagram of an example computing device according to the present disclosure.

FIG. 3 illustrates a model of component integration according to the present disclosure.

FIG. 4 illustrates a model of component integration according to the present disclosure.

FIG. 5 illustrates an architecture for data reconstruction according to the present disclosure.

FIG. 6 is a flow chart of an example of a method for data reconstruction according to the present disclosure.

### DETAILED DESCRIPTION

A cloud computing network can utilize a plurality of tools that can be used to automate deployment, arrangement, coordination, and/or management of computer systems, middleware, and services of the cloud computing network. The plurality of tools can also include enterprise architecture (EA) tools that collect and/or model information that relates to business transactions, applications that perform the business transactions and/or hardware and technology that execute the applications. Some examples of EA tools can include, but are not limited to: IBM System Architect, Sparx Enterprise Architect. As used herein, the term EA tool is intended to mean a tool that can at least organize the information via a data methodology (e.g., canonical model, non-canonical model, tree-like representation, etc.). A data methodology can include information relating to business functions with information relating to application functions that support the business functions and with information relating to application components that implement the application functions.

In some embodiments, the EA tools can include information from a perspective of multiple different users. For example, a first user can add information from a first perspective and a second user can add information from a second perspective. In this example, the information added by the first user and/or the second user can include a shortcut. That is, the information may not fully describe the execution of various applications that perform the shortcut. As used herein, a shortcut includes a number of intermediaries that are executed from a single selection. As used herein, intermediaries include executed applications and/or executed processes. In some embodiments, a user can describe information that includes a shortcut. The shortcut can include an execution of a plurality of applications. In some embodiments, a user that is describing the information may not have access to information relating to the plurality of applications that are executed via the shortcut and thus information relating to the plurality of applications may not be included in the data methodology. The shortcut can be categorized as a particular type of shortcut (e.g., shortcut type). As used herein, a shortcut type is a category of shortcuts that operate with the same and/or similar function.

In some embodiments, the shortcuts that are included in the EA tool can be identified and data can be collected that relates to the identified shortcuts. The data that is collected can include the type of applications that are executed via the shortcut and information that relates to the applications. As used herein, a data model includes a representation of data that can be in a canonical model, but also includes non-canonical model data types. As used herein, a canonical model includes a design pattern that is used to communicate between different data types. The data that is collected can be added to a data model corresponding to the EA tool. By collecting data relating to a shortcut and adding the data to the data model, a more complete data model corresponding to the EA tool can be provided and compared to EA tool data models without data relating to the shortcut. That is, the data relating to the shortcut can be useful information that may not have been included in previous methods of data construction for the EA tool. As used herein, data types include a categorization of data into a group that includes the same and/or similar features. For example, data types can include, but are not limited to: real, integer, and/or Boolean data types.

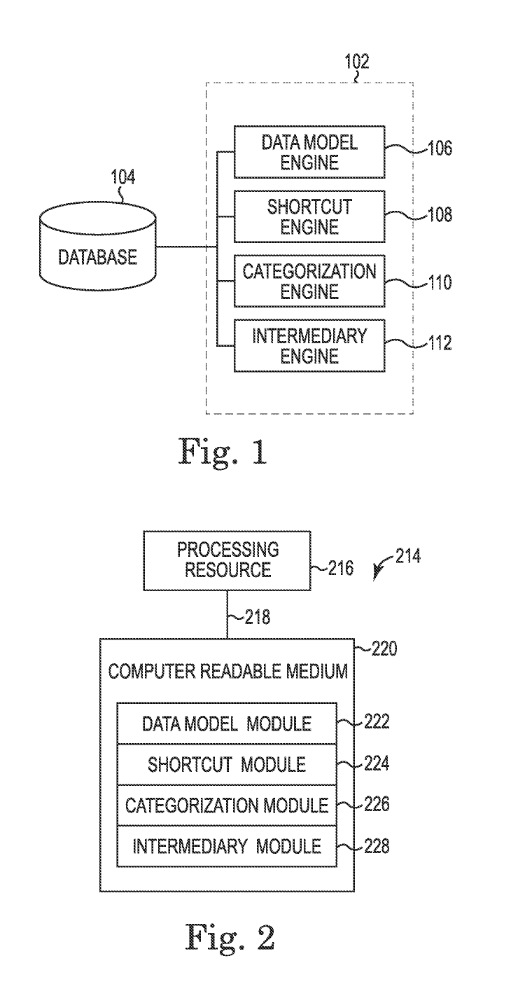

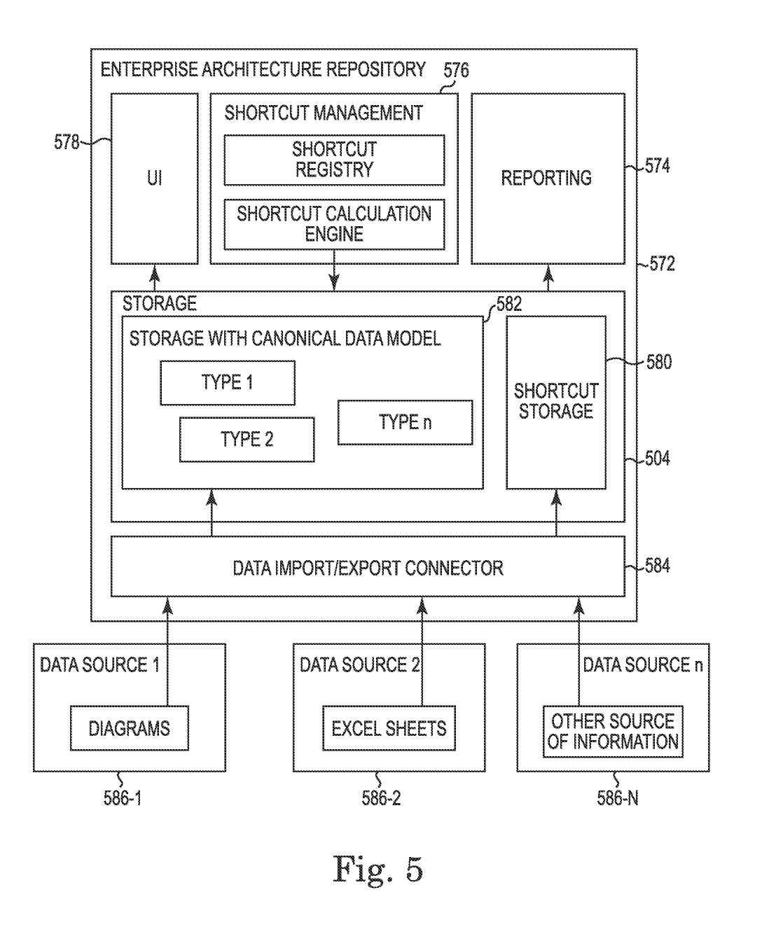

FIGS. 1 and 2 illustrate examples of system 100 and computing device 214 according to the present disclosure. FIG. 1 illustrates a diagram of an example of a system 100 for data reconstruction according to the present disclosure. The system 100 can include a database 104, a data reconstruction system 102, and/or a number of engines (e.g., data model engine 106, shortcut engine 108, categorization engine 110, intermediary engine 112). The data reconstruction system 102 can be in communication with the database 104 via a communication link, and can include the number of engines (e.g., data model engine 106, shortcut engine 108, categorization engine 110, intermediary engine 112). The data reconstruction system 102 can include additional or fewer engines that are illustrated to perform the various functions as will be described in further detail in connection with FIG. 5.

The number of engines (e.g., data model engine 106, shortcut engine 108, categorization engine 110, intermediary engine 112) can include a combination of hardware and programming, but at least hardware, that is configured to perform a number of functions described herein (e.g., generate a data model and receive a plurality of different data types, define shortcut types, identify a shortcut within the data model and categorize the identified shortcut into the defined shortcut types, determine unknown intermediaries of each of the identified shortcut based on the received plurality of different data types, etc.). The programming can include program instructions (e.g., software, firmware, etc.) stored in a memory resource (e.g., computer readable medium, machine readable medium, etc.) as well as hard-wired program (e.g., logic).

The data model engine 106 can include hardware and/or a combination of hardware and programming, but at least hardware, to generate a data model and receive a plurality of different data types to include within the data model. The data model engine 106 can generate a data model by replacing a canonical model with a data model that is capable of storing various different data types that are not necessarily canonical model data type. That is, the data model can be a representation of data that can be in a canonical model, but also includes non-canonical model data types. In some embodiments, the plurality of different data types includes information that relates to a shortcut. In certain embodiments, the shortcut may not be described with a high level of granularity (e.g., detail, information relating to execution, etc.). That is, information may be provided that indicates a shortcut exists, but the information may not include details of an operation (e.g., executed applications, types of applications executed, data utilized, etc.) of the shortcut.

The shortcut engine 108 can include hardware and/or a combination of hardware and programming, but at least hardware, to define shortcut types. Defining the shortcut types can include importing information that relates to known shortcuts that occur within a system. The information can include common shortcut names and/or references. In some embodiments, defining the shortcut types can include defining the shortcut types in a configuration file of an EA tool. As used herein, the configuration file is an initial setting for an application and/or operating system of an application. In some embodiments, the configuration file includes information relating to the application and/or operating system of the application.

The categorization engine 110 can include hardware and/or a combination of hardware and programming, but at least hardware, to identify a shortcut within the data model and categorize the identified shortcut into the defined shortcut types. The categorization engine 110 can identify the shortcut by comparing data within the data model to the defined shortcut types. The categorization engine 110 can categorize the identified shortcut into particular predefined shortcut types. Categorizing the identified shortcut into shortcut types can be beneficial when determining the intermediaries of the shortcut.

The intermediary engine 112 can include hardware and/or a combination of hardware and programming, but at least hardware, to determine unknown intermediaries of each of the identified shortcut based on the received plurality of different data types. The intermediary engine 112 can determine unknown intermediaries (e.g., executed applications, executed process, etc.) by utilizing the information within the plurality of different data types. For example, information relating to the unknown intermediaries can be included in the plurality of different data types.

FIG. 2 illustrates a diagram of an example computing device 214 according to the present disclosure. The computing device 214 can utilize software (e.g., program instructions), hardware, firmware, and/or logic to perform a number of functions described herein.

The computing device 214 can include a combination of hardware and program instructions configured to share information. The hardware, for example, can include a processing resource 216 and/or a memory resource 220 (e.g., computer-readable medium (CRM), machine readable medium (MRM), database, etc.). A processing resource 216, as used herein, can include any number of processors capable of executing program instructions stored by a memory resource 220. Processing resource 216 may be implemented in a single device or distributed across multiple devices. The program instructions (e.g., computer and/or machine readable instructions (CRI/MRI)) can include instructions stored on the memory resource 220 and executable by the processing resource 216 to implement a desired function (e.g., replace a canonical model with a data model that includes a plurality of different data types, identify data that is non-canonical model data types from the plurality of different data types, identify a shortcut within the data model and categorize the identified shortcut into defined shortcut types, determine unknown intermediaries of each of the identified shortcut based on the non-canonical model data, etc.).

The memory resource 220 can be in communication with a processing resource 216. A memory resource 220, as used herein, can include any number of memory components capable of storing instructions that can be executed by processing resource 216. Such memory resource 220 can be a non-transitory CRM or MRM. Memory resource 220 may be integrated in a single device or distributed across multiple devices. Further, memory resource 220 may be fully or partially integrated in the same device as processing resource 216 or it may be separate but accessible to that device and processing resource 216. Thus, it is noted that the computing device 214 may be implemented on a participant device, on a server device, on a collection of server devices, and/or a combination of the participant device and the server device.

The memory resource 220 can be in communication with the processing resource 216 via a communication link (e.g., a path) 218. The communication link 218 can be local or remote to a machine (e.g., a computing device) associated with the processing resource 216. Examples of a local communication link 218 can include an electronic bus internal to a machine (e.g., a computing device) where the memory resource 220 is one of volatile, non-volatile, fixed, and/or removable storage medium in communication with the processing resource 216 via the electronic bus.

As shown in the example of FIG. 2, the computing device 214 can include a number of modules (e.g., data model module 222, shortcut module 224, categorization module 226, intermediary module 228). As used herein, the term module is intended to include program instructions that when executed by the processing resource 216 can perform a number of functions. The number of modules (e.g., data model module 222, shortcut module 224, categorization module 226, intermediary module 228) can be combined with other modules or be sub-modules of other modules. The modules can be stored in a single memory resource. For example, the shortcut module 224 and the categorization module 226 can be sub-modules and/or contained within the same computing device. In another example, the number of modules (e.g., data model module 222, shortcut module 224, categorization module 226, intermediary module 228) can comprise individual modules at separate and distinct locations (e.g., CRM, etc.).

Each of the number of modules (e.g., data model module 222, shortcut module 224, categorization module 226, intermediary module 228) can include instructions that when executed by the processing resource 216 can function as a corresponding engine as described herein. For example, the data model module 222 can include instructions that when executed by the processing resource 216 can function as the data model engine 106. In another example, the shortcut module 224 can include instructions that when executed by the processing resource 216 can function as the shortcut engine 108. In another example, the categorization module 226 can include instructions that when executed by the processing resource 216 can function as the categorization engine 110. In another example, the intermediary module 228 can include instructions that when executed by the processing resource 216 can function as the intermediary engine 112.

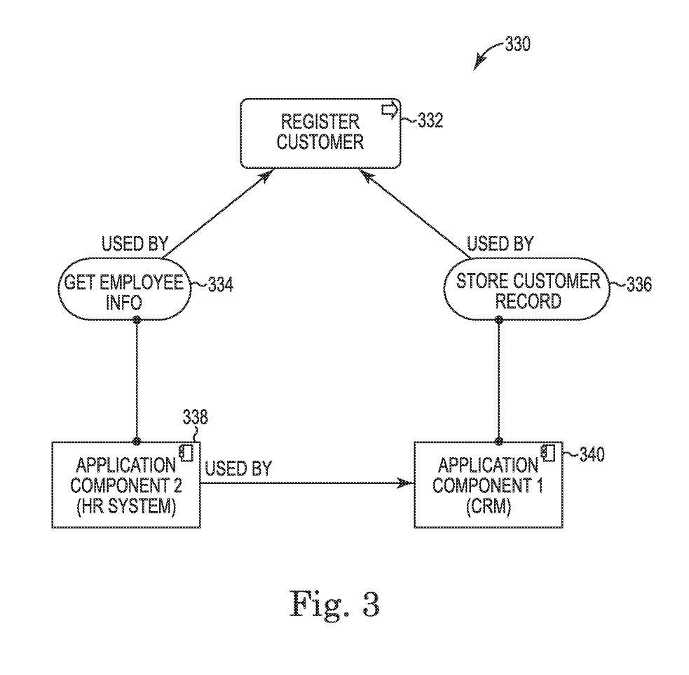

FIG. 3 illustrates a model 330 of component integration according to the present disclosure. The model 330 can be a canonical model of an application architecture. The model 330 can be a representation of an application architecture from a point of view (e.g., perspective, etc.) of a business. That is, the model 330 can be a high level representation of how an application architecture is integrated in a particular business process.

The model 330 can include an application component 338 that can be used by an application component 340. The application component 334 can be coupled to a business service 334. For example, the application component 334 can be coupled to the business service 334 that includes obtaining employee information. The business service 334 can be used by a business process 332 that includes utilizing the employee information to register a customer.

The application component 340 can be coupled to a business service 336 that includes storing a customer record. The business service 336 can be used by a business process 332 that includes utilizing the stored customer record for registering the customer.

The model 330 can give information that can be useful to a user who is interested in a business perspective of the application architecture. That is, the model 330 can include information about the application architecture that relates to business processes of the application architecture. The model 330 can include information that is relevant to particular users, however the model 330 may not include enough detail for particular interactions. For example, the model 330 includes business service 334 that includes obtaining employee information. In this example, there may not include additional information on what applications are utilized to perform the business service 334. In some embodiments, the additional information relating to the applications that are utilized can be relevant information and/or useful information for particular users.

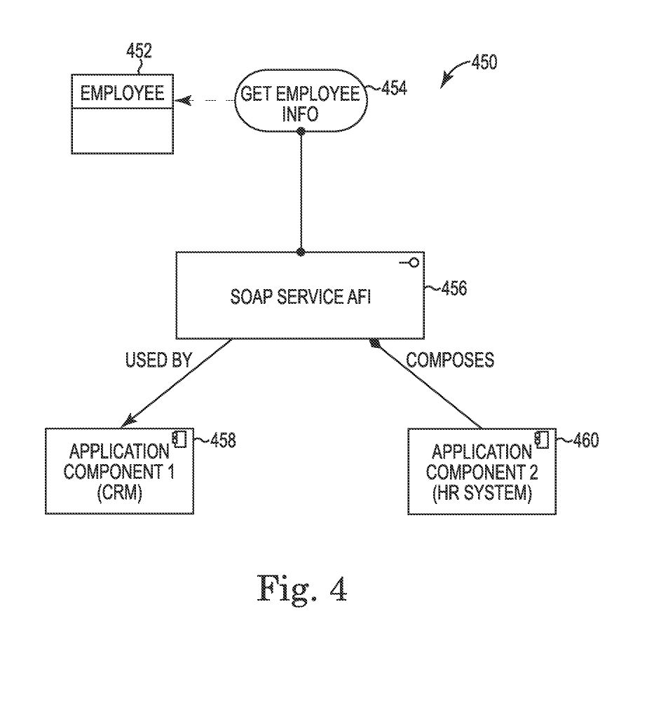

FIG. 4 illustrates a model 450 of component integration according to the present disclosure. The model 450 can be a representation of the same and/or similar application architecture as model 330 referenced in FIG. 3. However, the model 450 can be a canonical model of the application architecture from a different point of view (e.g., perspective, etc.). For example, the model 450 can be a canonical model from the perspective of an information technology (IT) user and/or system manager.

In some embodiments, the model 450 may include information that is overly detailed for a business perspective (e.g., information relating to specific applications executing the process, etc.), but can include desired information for an IT perspective. For example, the model 450 includes executing a SOAP service API 456 application that is utilized by the application component 440 and application component 438 to obtain the employee information 434 to identify an employee 452. In one example, the model 450 and the model 330 as referenced in FIG. 3 can be representations of the same application architecture that are generated for different perspectives. In this example, the model 330 as referenced in FIG. 3 can be generated for a perspective with interests in the business architecture of the application architecture and the model 450 can be generated for a perspective with interests in the software and/or hardware of the application architecture.

In some embodiments an EA tool can include one of the models (e.g., model 450, model 330 as referenced in FIG. 3, etc.) to represent the application architecture. By including one of the models, the EA tool can have a limited model that may include desired information for a particular perspective while not including desired information for a different perspective. It can be beneficial to provide an EA tool with a model that includes information for a variety of perspectives that reflect a variety of different areas of a business. For example, it can be beneficial to provide an EA tool with a model that includes the high level business architecture and the more specific software and/or hardware of the application architecture.

FIG. 5 illustrates an architecture 570 for data reconstruction according to the present disclosure. The architecture 570 can include a portion of an EA tool as described herein. That is, the enterprise architecture (EA) repository 572 can be a portion of the EA tool. The EA repository 572 can include CRM and/or MRM that can include instructions that when executed by a processing resource can perform the functions as described herein.

The EA repository can include a data import/export connector 584 that can import (e.g., receive) and/or export (e.g., send) information (e.g., data source 586-1, data source 586-2, data source 586-3, etc.). For example, the data import/export connector 584 can import from data source 586-1 that includes a number of diagrams/models in a canonical model that represents an application architecture. In addition, or alternatively, the data import/export connector 584 can import data from source 586-2 that includes excel spreadsheets with information corresponding to the application architecture. Furthermore, the import/export connector 584 can import data from source 586-N that includes various information (e.g., text descriptions, white papers, etc.) relating and/or corresponding to the application architecture. Thus, the import/export connector 584 can import a plurality of canonical model data types of information corresponding to a particular application architecture. In addition, the import/export connector 584 can import a plurality of non-canonical model data types of information corresponding to the particular application architecture.

The information that is imported by the data import/export connector 584 can be transferred (e.g., sent) to a storage device 504. The storage device 504 can be a database (e.g., database 104 as referenced in FIG. 1) that can store the information received and/or imported by the data import export connector 584. The information that is imported by the data import/export connector 584 can be separated into a number of categories (e.g., canonical data models 582, shortcuts 580, etc.). For example, a portion of information that is in a canonical data type format and/or non-canonical data type format can be categorized and stored in a canonical data model storage 582. In another example, a portion of information that is related to shortcuts can be stored in shortcut storage 580.

The information stored in the canonical data model storage 582 can include a variety of different data types (e.g., canonical data model types, non-canonical data model types, excel spreadsheets, white papers, type 1-type N, etc.). The storage device 504 can be coupled to a shortcut management tool 576. The shortcut management tool 576 can include a shortcut registry that can include information that relates to shortcuts that are identified and categorized in the shortcut storage 580. The information included in the shortcut registry can be utilized by a shortcut calculation engine to determine a number of unknown intermediaries that correspond to each identified shortcut.

The shortcut calculation engine can utilize information from the shortcut registry to determine unknown intermediaries for each of the identified shortcuts. The identified shortcuts can include an interaction (e.g., selection) that utilizes a plurality of applications and/or a plurality of interactions to perform a particular function. That is, the shortcuts can include a single interaction that executes/utilizes a plurality of applications and/or interactions to perform a function. The shortcuts can include interactions with a user interface that makes the execution of a function easier for a user compared to executing each of the plurality of interactions and/or applications that correspond to the shortcut.

When the unknown intermediaries of each of the identified shortcuts are calculated the intermediaries can be added to a data model (e.g., combined data model, canonical data model with non-canonical data model types, etc.) that combines the plurality of imported canonical data models relating to an application. Thus, a data model can be generated that includes information from multiple different perspectives by incorporating multiple imported canonical data models and determined intermediaries from the shortcut calculation engine. In some embodiments, the generated data model that includes the multiple imported canonical data models and determined shortcut intermediaries can be generated in a canonical data model type.

The generated data model can be exported and displayed on a user interface 578. As described herein, the generated data model can be displayed to a user and include information that is relevant to a variety of different perspectives since the generated data model can include multiple canonical data models from different perspectives and/or include previously unknown shortcut intermediaries. In addition, the generated data model can be exported via a number of reporting methods 574. For example, the generated model can be utilized to generate a corresponding report for a particular application.

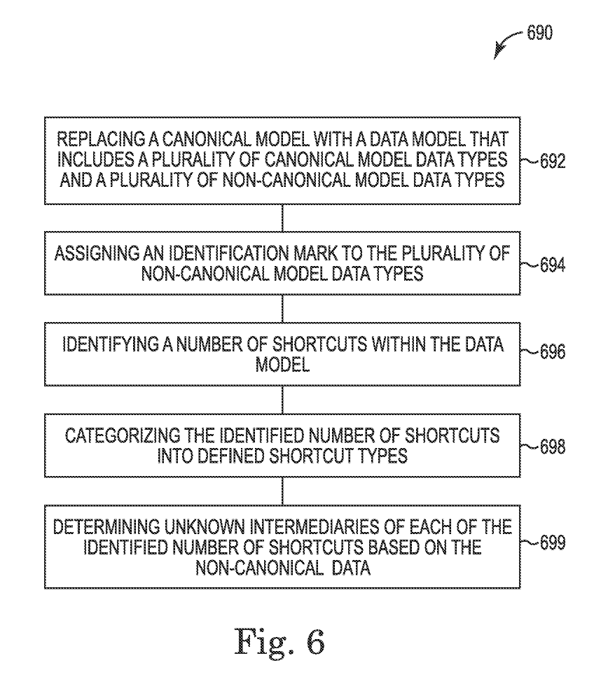

FIG. 6 is a flow chart of an example of a method 690 for data reconstruction according to the present disclosure. The method 690 can generate a data model for an EA tool that represents data that can be relative to a plurality of perspectives and/or needs of a system. For example, the method 690 can be utilized to generate a data model of an application architecture that can be used by a user with a perspective that is concerned with business level aspects of the application architecture and a user with a perspective that is concerned with hardware and/or software operation of the application architecture. In some embodiments, the method 690 can be performed utilizing a system (e.g., system 102 as referenced in FIG. 1) and/or a computing device (e.g., computing device 214 as referenced in FIG. 2).

At box 692 the method 690 can include replacing a canonical model with a data model that includes a plurality of canonical model data types and a plurality of non-canonical model data types. Replacing the canonical model can include generating a canonical model that is capable of storing non-canonical model data types. That is, replacing the canonical model of an EA tool can include incorporating non-canonical model data types and/or incorporating multiple canonical models that relate to a particular application architecture.

In some embodiments, there can be an existing canonical model that corresponds to a particular application architecture. In these embodiments, the existing canonical model can be replaced with a data model that includes a plurality of canonical model data types and a plurality of non-canonical model data types. In these embodiments, the exiting canonical model can include information that is more relative to a particular user compared to other users. For example, the existing canonical model can be generated by a first user with a particular desired set of information and/or perspective. In this example, the existing canonical model may not include information for a second user with a different desired set of information and/or perspective.

At box 694 the method 690 can include assigning an identification mark to the plurality of non-canonical model data types. Assigning an identification mark to the plurality of non-canonical model data types can include assigning an identification mark to data types that are not in the canonical model data type. For example, an identification mark can be assigned to data that is imported in an excel document and/or text document that includes information relating to a particular application architecture.

The identification mark can identify the data type of the non-canonical model data type. For example, the identification mark can identify that an imported data is in an excel document data type. The identification mark can be utilized to convert the non-canonical model data to canonical model data when generating the data model that includes the canonical model data types and the non-canonical model data types.

At box 696 the method 690 can include identifying a shortcut within the data model. Identifying the shortcut can include identifying shortcuts that are included in the plurality of canonical model data types that are imported. For example, a plurality of canonical model data types for a particular application architecture can be imported. In this example, each of the plurality of canonical model data types can include different information based on a particular perspective of the generation of the corresponding canonical model data. In each of the plurality of canonical model data types that are imported can include shortcuts that are not fully described. In addition, other canonical model data that is imported can include additional information relating to the shortcuts. The additional information can be included in the generated data model.

At box 698 the method 690 can include categorizing the identified shortcut into defined shortcut types. Categorizing the identified number of shortcuts can include placing each of the identified shortcut into a particular category. Categorizing the identified shortcut can be beneficial for a shortcut calculation engine to determine unknown intermediaries of the identified shortcuts. For example, a particular category can include shortcuts that operate in a similar manner. In this example, the particular category can include shortcuts that have a component that uses other components operation and a shortcut calculation engine can utilize information within a shortcut registry as described herein.

At box 699 the method 690 can include determining unknown intermediaries of each of the identified shortcut based on the non-canonical model data. Determining the unknown intermediaries can include utilizing imported information relating to the application architecture to determine a number of applications and/or interactions that are executed when a particular shortcut is utilized. The information that is utilized can be incorporated in the data model that includes the canonical model data type and non-canonical model data type. That is, information can be imported that relates to a particular application architecture and incorporated into a data model that utilizes both canonical model data and non-canonical model data. In some embodiments, the determined unknown intermediaries can be utilized to generate canonical model data types that include information that relates to the determined unknown intermediaries. The data model that is generated can be include more detailed information about an application architecture compared to existing canonical data models within an EA tool.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed is:

1. A system for data reconstruction, comprising:
a data model engine to generate a data model and receive a plurality of different data types to include within the data model;
a shortcut engine to define shortcut types;
a categorization engine to identify a shortcut within the data model and categorize the identified shortcut into the defined shortcut types; and
an intermediary engine to determine unknown intermediaries of the identified shortcut based on the received plurality of different data types.

2. The system of claim 1, wherein the data model includes a canonical model that is capable of storing the plurality of different data types.

3. The system of claim 2, wherein at least one of the plurality of different data types includes information relating to the shortcut.

4. The system of claim 1, wherein the shortcut engine is configured to define the shortcut types by defining shortcut types within a configuration file of the system.

5. The system of claim 1, wherein the shortcut includes a shortcut that utilizes a plurality of applications.

6. The system of claim 5, wherein the intermediary engine is configured to determine the plurality of applications and generate canonical model that includes the plurality of applications.

7. The system of claim 1, wherein the intermediary engine is configured to calculate a compliment for the shortcut based on the received plurality of different data types.

8. A non-transitory computer readable medium storing instructions executable by a processing resource to cause a controller to:
replace a canonical model with a data model that includes a plurality of different data types;
identify data that is non-canonical model data types from the plurality of different data types;
identify a shortcut within the data model and categorize the identified shortcut into defined shortcut types; and
determine unknown intermediaries of the identified shortcut based on the non-canonical model data.

9. The medium of claim 8, wherein the unknown intermediaries include unknown applications that are executed via a corresponding shortcut.

10. The medium of claim 8, comprising instructions to add information relating to the determined unknown intermediaries to the data model.

11. The medium of claim 10, wherein the added information is added in a canonical model data type.

12. A method for data reconstruction, comprising:
replacing a canonical model with a data model that includes a plurality of canonical model data types and a plurality of non-canonical model data types;
assigning an identification mark to the plurality of non-canonical model data types;
identifying a shortcut within the data model;
categorizing the identified shortcut into a defined shortcut type; and
determining unknown intermediaries of the identified shortcut based on the non-canonical model data.

13. The method of claim 12, wherein the identification mark distinguishes the plurality of canonical model data types from the non-canonical model data types.

14. The method of claim 12, wherein the plurality of canonical model data types are organized via a canonical model.

15. The method of claim 14, wherein the determined unknown intermediaries are utilized to generate canonical model data types that include information that relates to the determined unknown intermediaries.
